(19) United States
(12) Patent Application Publication
(10) Pub. No.: US 2010/0259180 A1
(43) Pub. Date: Oct. 14, 2010

(54) LED CIRCUIT AND METHOD FOR CONTROLLING THE AVERAGE CURRENT OF THE LED

(76) Inventors: Yuancheng Ren, Hangzhou (CN); Lei Du, Hangzhou (CN); Yong Huang, Tokyo (JP)

Correspondence Address: PERKINS COIE LLP;PATENT-SEA, P.O. BOX 1247, SEATTLE, WA, 98111-1247, US

(21) Appl. No.: 12/755,341

(22) Filed: Apr. 6, 2010

(30) Foreign Application Priority Data
Apr. 10, 2009 (CN) 200910058905.3

(51) Int. Cl. H05B 37/02

(52) U.S. Cl. 315/224

(57) ABSTRACT

An LED circuit is disclosed. The circuit senses the average current flowing through the LED. The sensed signal is compensated and modulated. The modulated signal is then used to control the ON/OFF state of a switch that supplies power to the LED.

### CROSS-REFERENCE TO RELATED APPLICATIONS

This application claims priority to and the benefit of Chinese Patent Application No. 200910058905.3, filed Apr. 10, 2009, which is incorporated herein by reference in its entirety.

### TECHNICAL FIELD

The technology described in this patent document relates generally to integrated circuits, and more particularly, to LED circuits.

### BACKGROUND

LED is rapidly replacing incandescent bulbs, fluorescent lamps, and other types of light sources due to its high efficiency, small size, high reliability, and long lifetime. FIG. 1 is a typical application of an LED used in a buck converter. As shown in FIG. 1, when a switch S₁ is turned on, a switch S₂ is turned off, an input V_{IN}, an inductor L, the LED, and the switch S₁ form a current loop. The current flowing through the inductor L and the LED increases. When the switch S₁ is turned off, the switch S₂ is turned on, the inductor L, the LED, and the switch S₂ form a current loop. The current flowing through the inductor L and the LED decreases. The switch S₂ is usually replaced by a freewheeling diode in use. The switch S₁ is put in the low side as shown, so that no floating drive circuit is needed.

The brightness of the LED is determined by the average current that flows. As a result, accurately controlling the average current of the LED is important. There are two current control methods which are adopted by conventional buck type LED circuits. Method 1 senses the current flowing through the low-side switch. This current sensing could be realized by the switch's own conductive resistance. Then the current is regulated by peak current mode control. This current control method is simple, with no external circuit or pin needed. In the peak current mode control, the peak value of the current is accurately controlled. However, because of the influence caused by the ripple, the error of the average current is large, which causes low precision.

Method 2 adopts a current sense resistor coupled in series with the LED. The current flowing through the LED is detected by the current sense resistor. Then the current is regulated by the average current mode control. This current control method has high precision. However, the series coupled current sense resistor introduces additional power loss.

### BRIEF DESCRIPTION OF THE DRAWINGS

FIG. 1 illustrates a typical application of LED used in a buck type converter.

FIG. 2 illustrates a circuit 100 which accurately control the average current of the LED in accordance with an embodiment of the present invention.

FIG. 3 illustrates waveforms of the drive signal of a main switch, the current flowing through the main switch, and the current flowing through the LED of circuit 100 of FIG. 2.

FIG. 4 illustrates the principle of a mid-current sense method.

FIG. 5 illustrates a circuit 200 which realizes the mid-current sense method of FIG. 4 in accordance with an embodiment of the present invention.

FIG. 6 illustrates a pulse signal generating circuit 50.

FIG. 7 illustrates waveforms of signals \textcircled{1}, \textcircled{2}, \textcircled{3}, and G_{Q1} generated by the pulse generating circuit 50 of FIG. 6.

FIG. 8 illustrates waveforms of the current I_{LEA} flowing through the LED, the current I_{S0} flowing through the main switch current, the control signal of the first switch G_{Q1}, and the sense signal Iₛₑₙₛₑ of circuit 100 of FIG. 5.

FIG. 9 illustrates a sense unit 10 which realizes the full-wave sense.

FIG. 10 illustrates waveforms of the drive signal V_{Dr}, the current I_{S0} flowing through the main switch current, and the sense signal Iₛₑₙₛₑ of the sense circuit 10 of FIG. 9.

FIG. 11 illustrates a modulate unit 30 in accordance with an embodiment of the present invention.

FIG. 12 illustrates a modulate unit 30 in accordance with another embodiment of the present invention.

FIG. 13 illustrates waveforms of signals A, B, C, D, E, F, G, and the compensated signal V_{M} of FIG. 12.

FIG. 14 illustrates a method 300 controlling the average current of the LED in accordance with yet another embodiment of the present invention.

FIG. 15 illustrates a flowchart 400 of the mid-current sense in accordance with yet another embodiment of the present invention.

FIG. 16 illustrates a method 500 controlling the average current of the LED in accordance with yet another embodiment of the present invention.

FIG. 17 illustrates a flowchart 600 of the full-wave sense in accordance with yet another embodiment of the present invention.

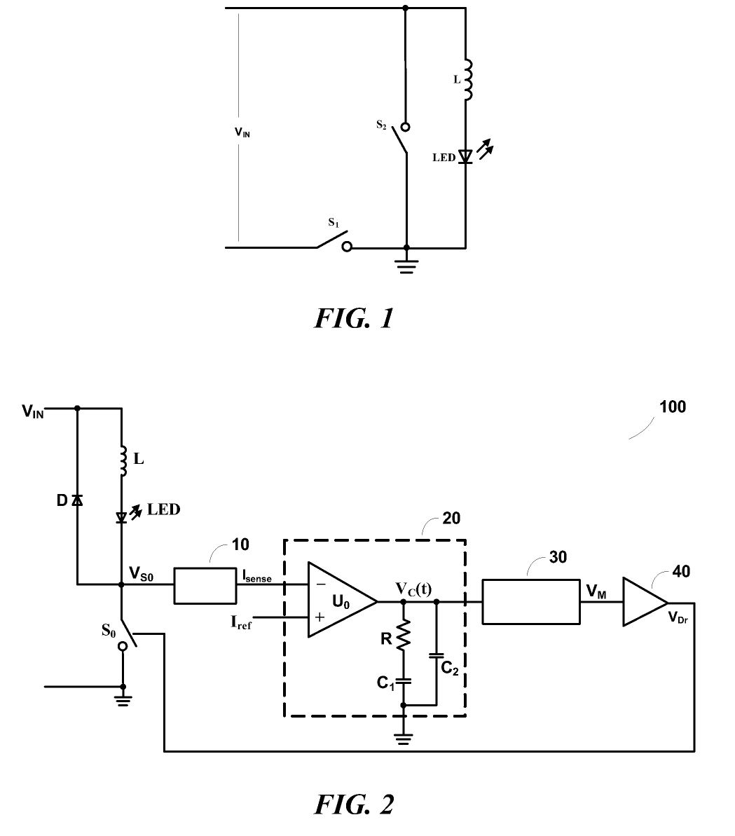

### DETAILED DESCRIPTION

Referring to FIG. 2, a circuit 100 which accurately controls the average current of the LED in accordance with an embodiment of the present invention is shown. As shown in FIG. 2, circuit 100 comprises a typical buck converter comprised by an input port V_{IN}, a main switch S₀, a freewheeling diode D, an inductor L and a LED. That is, the LED is coupled in series with the inductor L, the series coupled LED and the inductor L are coupled in parallel with the freewheeling diode D which is coupled between the input port V_{IN} and ground via the main switch S₀. Circuit 100 further comprises a sense unit 10, a compensation unit 20, a modulate unit 30 and a drive circuit 40. The input terminal of the sense unit 10 is coupled to the high terminal of the main switch S₀, the output terminal of the sense unit 10 is coupled to one input terminal of the compensation unit 20. The other input terminal of the compensation unit 20 receives a reference signal I_{ref}. The output terminal of the compensation unit 20 is coupled to the modulate unit 30. The modulate unit 30 provides a modulated signal V_{M} which is delivered to the control terminal of the main switch S₀ via the drive circuit 40, so as to control the ON/OFF of the main switch S₀.

In one embodiment, the compensation unit 20 includes an operational amplifier U₀ and a RC filter. The RC filter comprises a resistor R, a capacitor C₁, and a capacitor C₂. The inverting input terminal of the operational amplifier U₀ acts as one input terminal of the compensation unit 20, which receives the sense signal Iₛₑₙₛₑ provided by the sense unit 10. The non-inverting input terminal of the operation amplifier U₀ acts as the other input terminal of the compensation unit 20 which receives the reference I_{ref}. The resistor R and the capacitor C₁ are coupled in series between the output terminal of the operation amplifier U₀ and ground. The capacitor C₂ is coupled between the output terminal of the operation amplifier U₀ and ground. When the circuit 100 is in operation, the operation amplifier U₀ amplifies the difference between the sense signal Iₛₑₙₛₑ and the reference signal I_{ref}, and integrates the amplified signal into the capacitor C₂. In other words, a compensated signal V_{C}(t) provided by the operation amplifier U₀ represents the amplified signal. If the sense signal Iₛₑₙₛₑ is higher than the reference signal I_{ref}, the compensated signal V_{C}(t) decreases; if the sense signal Iₛₑₙₛₑ is lower than the reference signal I_{ref}, the compensated signal V_{C}(t) increases; if the sense signal Iₛₑₙₛₑ is equal to the reference signal I_{ref}, the compensated signal V_{C}(t) is held. As a result, the compensation unit 20 regulates the signal at the inverting input terminal of the operation amplifier U₀ to follow the reference signal.

When the main switch S₀ is turned on, the current flowing through the main switch S₀ is the current flowing through the LED. The sense unit 10 receives the voltage V_{S0} across the main switch S₀, and provides the sense signal Iₛₑₙₛₑ to the non-inverting input terminal of the operation amplifier U₀. The voltage V_{S0} is the product of the current I_{S0} flowing through the main switch S₀ and its conduct resistance. The difference of the sense signal Iₛₑₙₛₑ and the reference signal I_{ref} is amplified by the operation amplifier U₀; the amplified signal is filtered by the RC filter to get the compensated signal V_{C}(t). Then the compensated signal V_{C}(t) is modulated in the modulate unit 30. The modulated signal V_{M} is used to drive the main switch S₀ via the drive circuit 40. The operation of the sense unit 10 and the modulate unit 30 will be illustrated hereinafter.

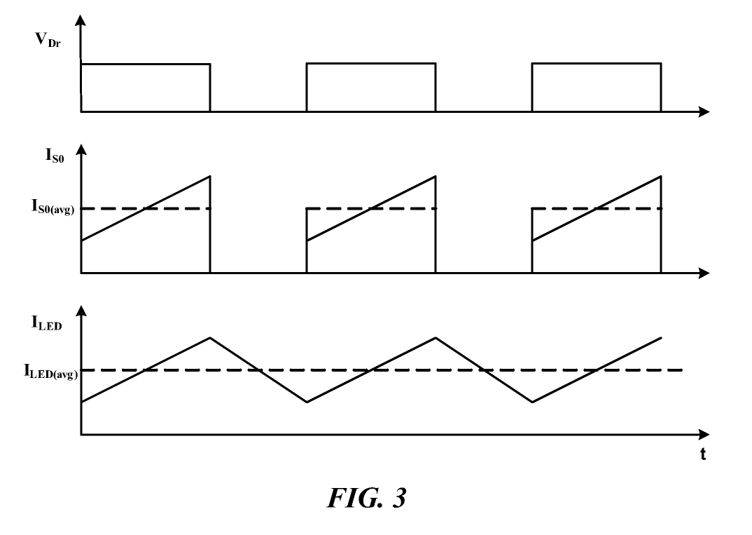

When the main switch S₀ is turned on, the current flowing through the main switch S₀ is the current flowing through the LED. So the average current I_{S0(avg)} of the main switch S₀ is equal to the average current I_{LED(avg)} of the LED during the ON period of the main switch S₀, as shown in FIG. 3. As a result, the average current of the LED could be regulated by regulating the average current of the main switch S₀ during its ON period.

Two current sense methods are disclosed as follows.

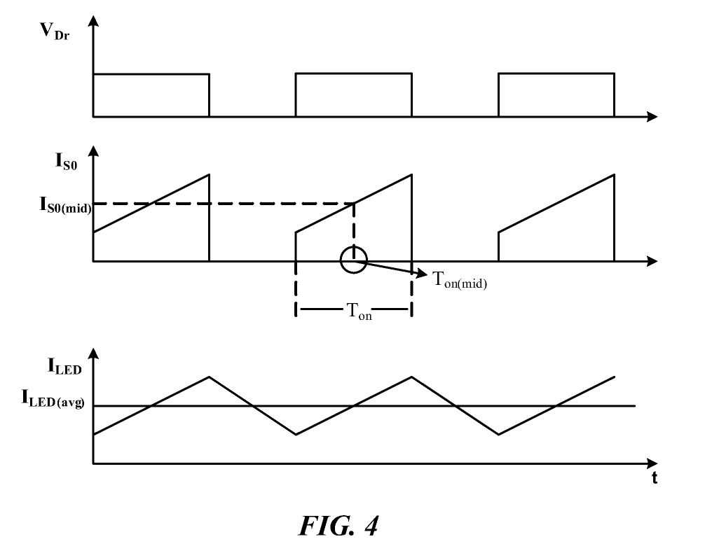

Method 1 is defined as mid-current sense, whose principle is shown in FIG. 4. The current I_{S0} flowing through the main switch S₀ is the current I_{LED} flowing through the LED during the ON period of the main switch S₀. For illustration purpose, the current at the mid time point of the main switch S₀'s ON time is referred to as mid-current I_{S0(mid)}. As shown in FIG. 4, the mid-current I_{S0(mid)} is equal to the average current I_{S0(avg)} of the main switch during its ON period. Thus I_{S0(mid)}=I_{S0(avg)}=I_{LED(avg)}. Accordingly, if the mid-current I_{S0(mid)} is sensed and held, the average current of the LED is sensed, which is further regulated by the compensation unit 20 and the modulate unit 30.

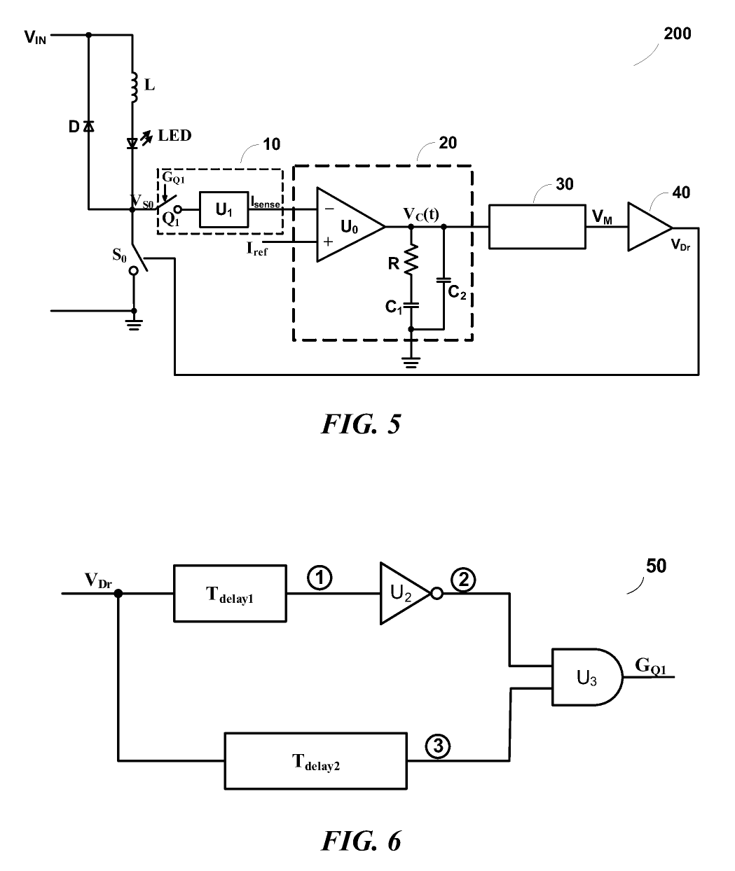

Referring to FIG. 5, a circuit 200 which realizes the mid-current sense method of FIG. 4 is illustrated. In one embodiment, the sense unit 10 comprises a first switch Q₁ and a hold circuit U₁ coupled in series. The sense unit 10 delivers the sense signal Iₛₑₙₛₑ to the compensation unit 20, so as to insure that the sense signal Iₛₑₙₛₑ follows the reference signal I_{ref}. The control signal G_{Q1} of the first switch Q₁ is generated by a pulse signal generating circuit 50 shown in FIG. 6. The pulse signal generating circuit 50 comprises a first delay circuit T_{delay1} and a second delay circuit T_{delay2}, both of which receive the drive signal V_{Dr} provided by the drive circuit 40. The first delay circuit T_{delay1} provides a first delay signal \textcircled{1} to the first inverter U₂ to get a delay-invert signal \textcircled{2}. The delay-invert signal \textcircled{2} is delivered to one input terminal of the AND gate U₃. The second delay circuit T_{delay2} provides a second delay signal \textcircled{3} to the other input terminal of the AND gate U3. The output signal of the AND gate U₃ is the desired control signal G_{Q1} of the first switch Q₁ in the sense unit 10 of FIG. 5. The delay time of the first delay circuit T_{delayl} is

$$\frac{{T}_{ON}}{2} ,$$

and the second delay circuit T_{delay2} is

$$\frac{{T}_{ON}}{2} - {T}_{1} ,$$

wherein T_{ON} is the ON time period of the main switch S₀ in one cycle, i.e., the duration of the high level of the drive signal V_{Dr}.

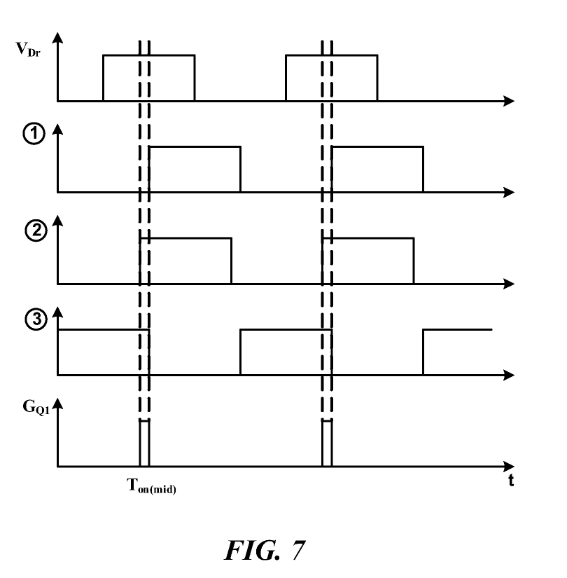

FIG. 7 illustrates waveforms of signals \textcircled{1}, \textcircled{2}, \textcircled{3}, and G_{Q1} generated by the pulse generating circuit 50 of FIG. 6. As shown in FIG. 7, the control signal G_{Q1} is a pulse signal. In order to insure the error caused by the mid-current I_{S0(mid)} to be lower than a certain K, the pulse width of the T_{ON(mid)} should be lower than K^{1/2}×T_{ON}, wherein K is a desired precision. In one embodiment, T₁ in the delay time of the second delay circuit T_{delay2} is a time constant, which is set for the system precision.

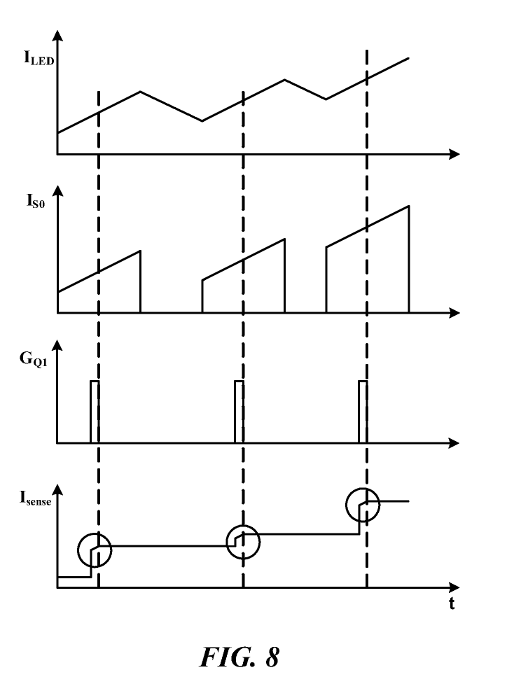

Referring to FIG. 8, the waveforms of circuit 100 of FIG. 5 is shown. As shown in FIG. 8, the sense signal Iₛₑₙₛₑ varies with the current flowing through the LED, wherein the cycle of the sense signal Iₛₑₙₛₑ starts from the mid time point of the main switch S₀'s ON time, ends at the mid time point of the main switch S0's next ON time. As illustrated hereinbefore, the average current of the LED is accurately sensed by the mid-current sense method.

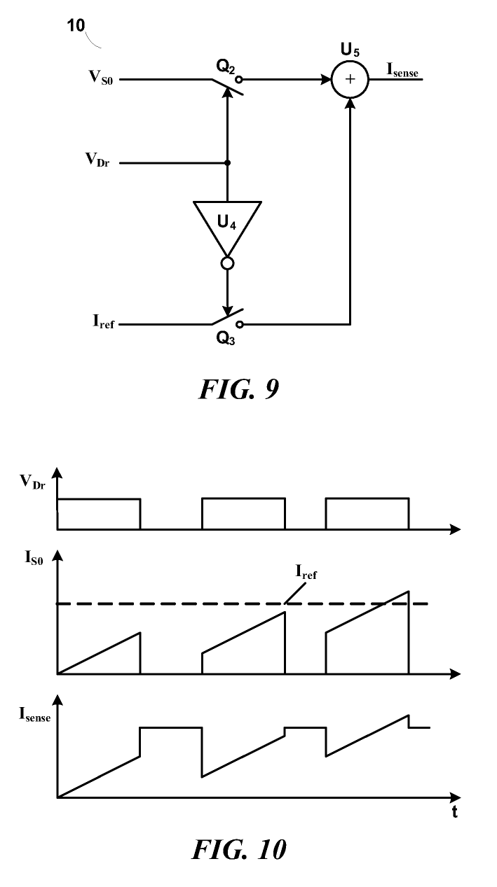

Method 2 is defined as full-wave sense. The corresponding circuit of the sense unit 10 is shown in FIG. 9. As shown in FIG. 9, the sense unit 10 comprises a second switch Q₂ which receives a voltage signal V_{S0} across the main switch S₀; a third switch Q₃ which receives the reference signal I_{ref}. Because the voltage signal V_{S0} is the product of the current I_{S0} flowing through the main switch S₀ and its conduct resistance, the voltage signal V_{S0} represents the current I_{S0}. The second switch Q₂ is controlled by the drive signal V_{Dr} which also controls the ON/OFF of the main switch S₀, i.e., the second switch Q₂ is synchronized with the main switch S₀; the third switch Q₃ is controlled by the inverted signal of the drive signal V_{Dr}. That is, a first terminal of the second switch Q₂ is coupled to the high terminal of the main switch S₀, the control terminal of the second switch Q₂ is coupled to the control terminal of the main switch S₀; a first terminal of the third switch Q₃ receives the reference signal I_{ref}, the control terminal of the third switch Q₃ is coupled to the control terminal of the main switch S₀ via a second inverter U₄.

A second terminal of the second switch Q₂ is coupled to a first terminal of a first adder U₅, a second terminal of the third switch Q₃ is coupled to a second input terminal of the first adder U₅. The output signal of the first adder U₅ is the desired sense signal Iₛₑₙₛₑ. The operation of the sense unit 10 is illustrated in detail as follows.

When the main switch S₀ is turned on, the second switch Q₂ is turned on as well, the third switch Q₃ is turned off. The second switch Q₂ delivers the current signal I_{S0} to the first adder U₅, the third switch Q₃ disconnects the reference signal I_{ref} to the first adder U₅. Accordingly, the sense signal Iₛₑₙₛₑ is the current signal I_{S0}. When the main switch S₀ is turned off, the second switch Q₂ is turned off, the third switch Q₃ is turned on. As a result, the second switch Q₂ disconnects the current signal I_{S0} to the first adder U₅, the third switch Q₃ delivers the reference signal I_{ref} to the first adder U5. Accordingly, the sense signal Iₛₑₙₛₑ is the reference signal I_{ref}. Waveforms of the drive signal V_{Dr}, the current I_{S0} flowing through the main switch S₀, and the sense signal Iₛₑₙₛₑ are shown in FIG. 10. For the existence of the compensation circuit 20, the sense signal Iₛₑₙₛₑ follows the reference signal I_{ref}. In addition, the sense signal Iₛₑₙₛₑ is equal to the reference signal I_{ref} during the main switch S₀'s OFF time. This full-wave sense method insures the average current of the main switch S₀ to be equal to the reference signal during the ON period of the main switch S₀, i.e., insures the average current of the LED to be equal to the reference signal.

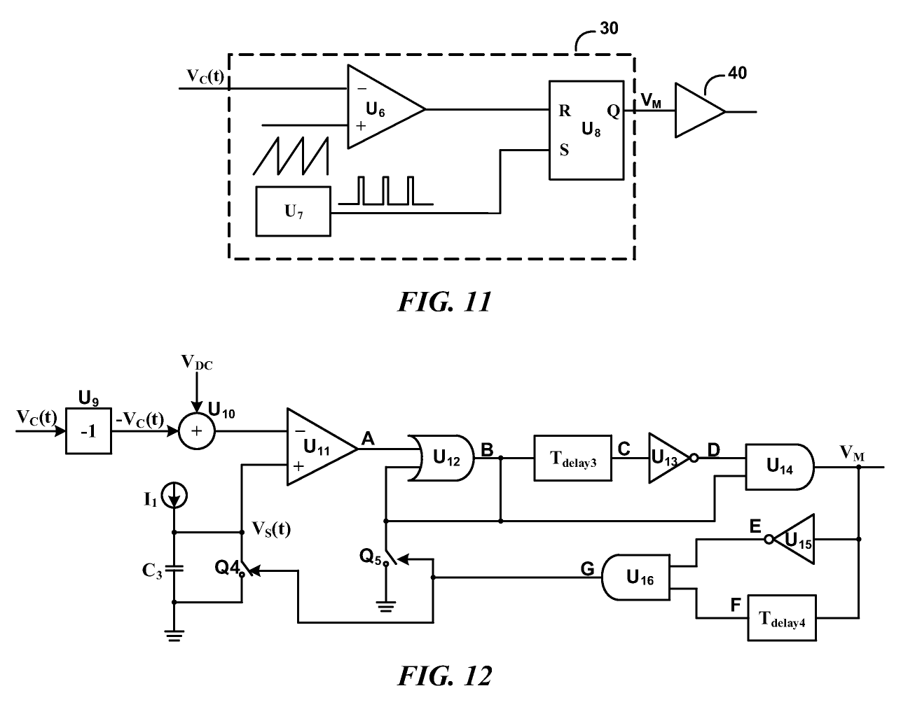

The average current I_{S0(avg)} could be accurately modulated via the modulator 30 based on the sense signal provided by the mid-current sense method and the full-wave sense method. Referring to FIG. 11, a modulate unit 30 in accordance with an embodiment of the present invention is illustrated. As shown in FIG. 11, the modulate unit 30 is a well-known PWM modulator. The modulate unit 30 comprises a comparator U₆, a clock signal generator U₇, a RS flip-flop U₈. The inverting input terminal of the comparator U₆ receives the compensated signal V_{C}(t), the non-inverting input terminal of the comparator U₆ receives a saw-tooth signal provided by the clock signal generator U₇, the output terminal of the comparator U₆ is coupled to a reset terminal R of the RS flip-flop U₈. The clock signal provided by the clock signal generator U₇ is delivered to a set terminal S of the RS flip-flop U₈. The output signal Q of the RS flip-flop U₈ is the desired modulated signal V_{M}. The modulated signal V_{M} is used to drive the main switch S₀ via the drive circuit 40.

On one hand, when the rising edge of the clock signal arrives, the RS flip-flop U₈ is reset, so the modulated signal V_{M} goes high, and the main switch S₀ is turned on via the drive circuit 40. The current I_{S0} flowing through the main switch S₀ increases, i.e., the current I_{LED} flowing through the LED increases. As a result, the sense signal Iₛₑₙₛₑ increases, which causes the compensated signal V_{C}(t) to decrease. On the other hand, the saw-tooth signal slowly increases. When it increases to be higher than the compensated signal V_{C}(t), the output of the comparator U₆ turns to high, which resets the RS flip-flop U₈. Then the main switch S₀ is turned off via the drive circuit 40.

If the average current I_{LED(avg)} of the LED is higher than the reference signal I_{ref}, the compensated signal V_{C}(t) is relatively low. Accordingly, the saw-tooth signal touches the compensated signal V_{C}(t) earlier, which resets the RS flip-flop U₈ earlier, causing the ON time of the main switch to be shorter. As a result, the average current I_{LED(avg)} of the LED decreases. If the average current I_{LED(avg)} of the LED is lower than the reference signal I_{ref}, the compensated signal V_{C}(t) is relatively high. Accordingly, the saw-tooth signal touches the compensated signal V_{C}(t) later, which resets the RS flip-flop U₈ later, causing the ON time of the main switch to be longer. As a result, the average current I_{LED(avg)} of the LED increases.

Through such regulation of the modulate unit 30, the average current I_{LED(avg)} of the LED is accurately controlled.

Referring to FIG. 12, a modulate unit 30 in accordance with another embodiment of the present invention is illustrated. In one embodiment, the modulate unit 30 is a constant on-time modulation circuit. The constant on-time modulation keeps ON time of a switch to be constant in each cycle, but varies the switch frequency.

As shown in FIG. 12, the modulate unit 30 comprises a multiplier Ug whose coefficient is −1, i.e., the output of the multiplier U₉ is −V_{C}(t), which is delivered to a first input terminal of a second adder U₁₀. A second input terminal of the second adder U₁₀ receives a DC offset V_{DC}. The DC offset V_{DC} is set to insure that the output signal (V_{DC}-V_{C}(t)) of the adder U₁₀ is above zero all the time. The signal (V_{DC}-V_{C}(t)) is sent to the inverting input terminal of the comparator U₁₁, while the non-inverting input terminal of the comparator U₁₁ receives a saw-tooth signal V_{S}(t). The saw-tooth signal V_{S}(t) is generated by a saw-tooth signal generator which comprises a current source I₁, a capacitor C₃, and a fourth switch Q₄. The output signal A of the comparator U₁₁ is sent to a first input terminal of an OR gate U₁₂. A second input terminal of the OR gate U₁₂ is coupled to ground via a fifth switch Q₅. The second input terminal of the OR gate U₁₂ is also coupled to its output terminal which is further coupled to an input terminal of a third delay circuit T_{delay3} and a first input terminal of an AND gate U₁₄. The third delay circuit T_{delay3} provides an output signal C which is delivered to an inverter U₁₃, to get an inverted signal D which is sent to a second input terminal of the AND gate U₁₄. The output signal V_{M} of the AND gate U₁₄ is the desired modulated signal, which is sent to the drive circuit 40. The modulated signal V_{M} is further sent to a fourth inverter U₁₅ to get a signal E, and is sent to a fourth delay circuit T_{delay4} to get a signal F. The signal E and the signal F are sent to an AND gate U₁₆ to get a AND signal G which is used to control the ON/OFF of the fourth switch Q₄ and the fifth switch Q₅.

When the saw-tooth signal V_{S}(t) touches the level of the signal (V_{DC}-V_{C}(t)), the output signal A of the comparator U₁₁ goes high. The signal B goes high as well. Accordingly, the modulated signal V_{M} is determined by the signal D at the second input terminal of the AND gate U₁₄. Because the effect of the third delay circuit T_{delay3}, the signal C goes high later than the signal B a time period of T_{d3}. The signal D is an inverted signal of the signal C. Thus from the time point the signal B goes high, to the time point the delay time period T_{d3} ends, the modulated signal V_{M} is high. That is, the modulated signal V_{M} retains high for a time period of T_{d3}. The constant on-time T_{ON} is determined by the delay time T_{d3} of the third delay circuit T_{delay3}.

The delay time T_{d4} of the fourth delay circuit T_{delay4} is relatively short, which could be regarded as a short pulse time period. When the modulated signal V_{M} turns to low after the time period T_{d3}, the signal E turns to high. However, the signal F turns to high later than the signal E a time period of T_{d4}. As a result, the signal G is a short pulse. The fourth switch Q₄ and the fifth switch Q₅ are turned on during this short pulse time period. And the saw-tooth signal V_{S}(t) is reset to zero, the output signal A of the comparator U₁₁ turns to low. In the meantime, signal B is pulled to ground. After the short pulse time period T_{d4}, the saw-tooth signal V_{S}(t) increases from zero, and the signal B keeps low until the saw-tooth signal V_{S}(t) touches the level of the signal (V_{DC}-V_{C}(t)) again. Then the signal A turns to high, a new cycle begins.

If the average current I_{LED(avg)} is higher than the reference signal I_{ref}, the compensated signal V_{C}(t) decreases, which causes (V_{DC}-V_{C}(t)) to increase. Accordingly, the saw-tooth signal V_{S}(t) touches the signal (V_{DC}-V_{C}(t)) later, and the low-level time of the signal A becomes longer, so as the signal B and the compensated signal V_{M}. On the other hand, if the average current I_{LED(avg)} is lower than the reference signal I_{ref}, the compensated signal V_{C}(t) increases, which causes (V_{DC}-V_{C}(t)) to decrease. Accordingly, the saw-tooth signal V_{S}(t) touches the signal (V_{DC}-V_{C}(t)) earlier, and the low-level time of the signal A becomes shorter, so as the signal B and the compensated signal V_{M}.

From the above illustration, the modulated signal V_{M} is the desired modulation signal whose high-level time period is constant while low-level time period is varied according to the average current I_{LED(avg)} of the LED. So the average current I_{LED(avg)} could be accurately controlled by such regulation.

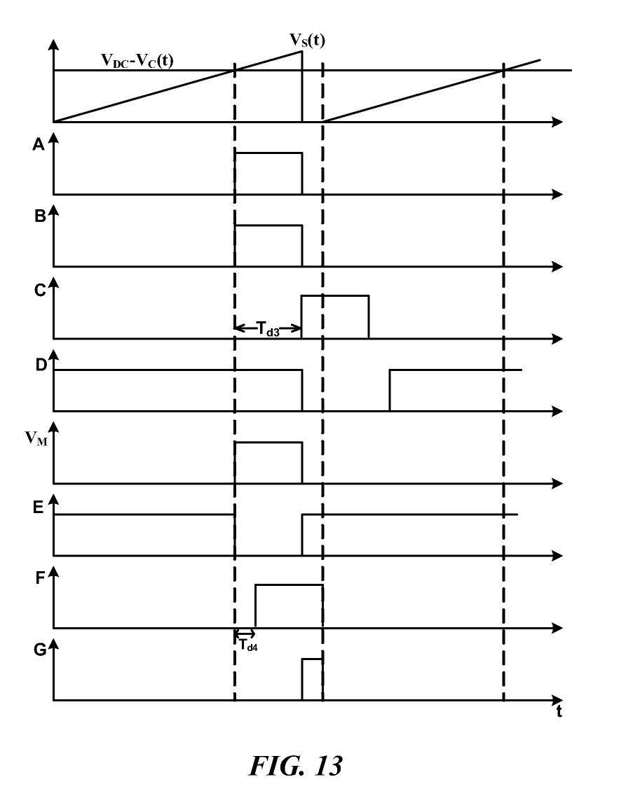

FIG. 13 illustrates waveforms of signals A, B, C, D, E, F, G, and the compensated signal V_{M} of FIG. 12.

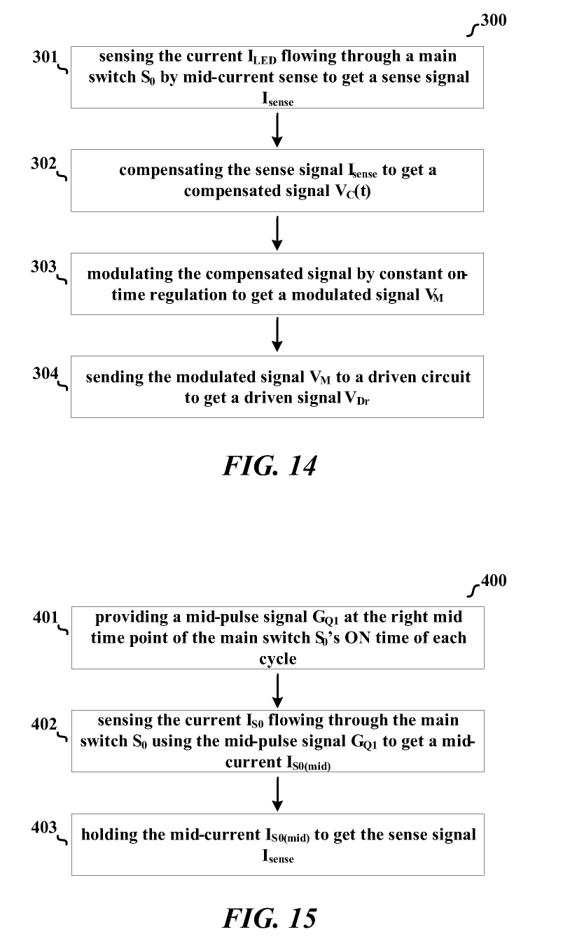

Referring to FIG. 14, a method 300 controlling the average current of the LED in accordance with yet another embodiment of the present invention is illustrated. The method 300 comprises the following steps: step 301, sensing the current I_{LED} flowing through a main switch S₀ by mid-current sense to get a sense signal Iₛₑₙₛₑ; step 302, compensating the sense signal Iₛₑₙₛₑ to get a compensated signal V_{C}(t); step 303, modulating the compensated signal V_{C}(t) by constant on-time regulation to get a modulated signal V_{M}; step 304, sending the modulated signal V_{M} to a drive circuit to get a drive signal V_{Dr} which is used to control the ON/OFF of the main switch S₀.

Referring to FIG. 15, a flowchart 400 of the mid-current sense is illustrated in accordance with yet another embodiment of the present invention. It comprises: step 401, providing a mid-pulse signal G_{Q1} at the right mid time point of the main switch S₀'s ON time of each cycle; step 402, sensing the current I_{S0} flowing through the main switch S₀ using the mid-pulse signal G_{Q1} to get a mid-current I_{S0(mid)}; step 403, holding the mid-current I_{S0(mid)} to get the sense signal Iₛₑₙₛₑ.

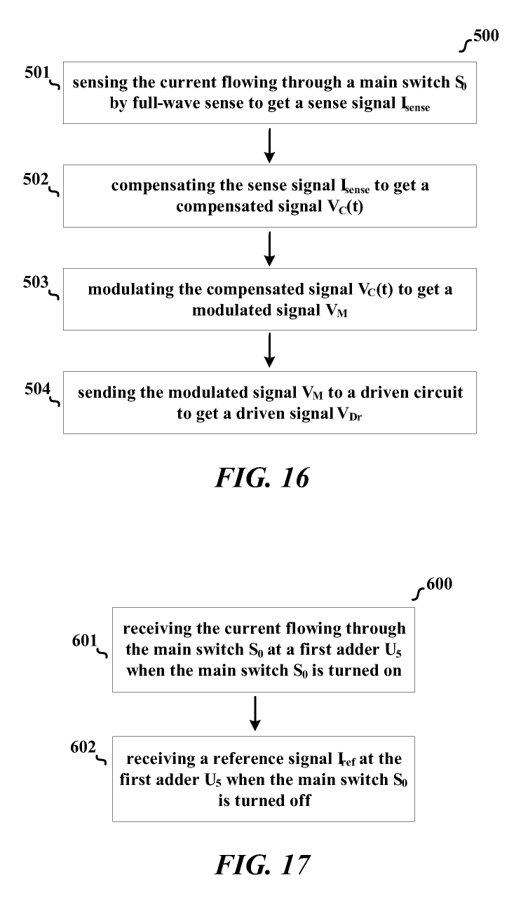

Referring to FIG. 16, a method 500 controlling the average current of the LED accordance with yet another embodiment of the present invention is illustrated. The method 500 comprises: step 501, sensing the current flowing through a main switch S₀ by full-wave sense to get a sense signal Iₛₑₙₛₑ; step 502, compensating the sense signal Iₛₑₙₛₑ to get a compensated signal V_{C}(t); step 503, modulating the compensated signal V_{C}(t) to get a modulated signal V_{M}; step 504, sending the modulated signal V_{M} to a drive circuit to get a drive signal which is used to control the ON/OFF of the main switch S₀.

Referring to FIG. 17, a flowchart 600 of the full-wave sense is illustrated in accordance with yet another embodiment of the present invention. It comprises: step 601, receiving the current flowing through the main switch S₀ at a first adder U₅ when the main switch S₀ is turned on; step 602, receiving a reference signal I_{ref} at the first adder U₅ when the main switch S₀ is turned off. The output signal provided by the first adder U₅ is the desired sense signal Iₛₑₙₛₑ.

This written description uses examples to disclose the invention, including the best mode, and also to enable a person skilled in the art to make and use the invention. The patentable scope of the invention may include other examples that occur to those skilled in the art.

I/We claim:

1. A LED circuit, comprising:
a switch circuit which includes a main switch;
a sense unit, coupled to the switch circuit to sense and hold the current flowing through the main switch at the mid-point when the main switch is ON in each cycle, the sense unit operable to provide a sense signal;
a compensation unit, operable to provide a compensated signal in respond to the sense signal and a reference signal;
a modulate unit, operable to provide a modulated signal in respond to the compensated signal; and
a drive circuit, operable to provide a drive signal in response to the modulated signal to drive the main switch in the switch circuit.

2. The LED circuit of claim 1, wherein the sense unit comprises a first switch and a hold circuit coupled in series.

3. The LED circuit of claim 2, wherein the sense unit further comprises:
a first delay circuit, operable to provide a first delay signal in respond to the drive signal;
a first inverter, coupled in series with the first delay circuit, operable to provide a delay-invert signal in respond to the first delay signal;
a second delay circuit, operable to provide a second delay signal in respond to the drive signal; and
a AND gate, operable to provide a signal used to drive the first switch in respond to the delay-invert signal and the second delay signal.

4. The LED circuit of claim 1, wherein the modulation unit is a constant on-time modulation circuit.

5. The LED circuit of claim 1, wherein the compensation unit comprises:
an operation amplifier, operable to receive the sense signal and the reference signal, the operation amplifier operable to amplify the difference between the sense signal and the reference signal; and
a RC filter, coupled between the output of the operation amplifier and ground.

6. A LED circuit, comprising:
a switch circuit which includes a main switch;
a sense unit, coupled to the switch circuit to sense the current flowing through the main switch, operable to provide a sense signal in respond to the sensed current and a reference signal;
a compensation unit, operable to provide a compensated signal in respond to the sense signal and the reference signal;
a modulate unit, operable to provide a modulated signal in respond to the compensated signal; and
a drive circuit, operable to provide a drive signal in respond to the modulated signal to drive the main switch in the switch circuit.

7. The LED circuit of claim 6, wherein the sense unit comprises:
a second switch, operable to deliver the sensed current to a first adder when turned on, and disconnect the sensed current to the first adder when turned off;
a third switch, operable to deliver the reference signal to the first adder when turned on, and disconnect the reference signal to the adder when turned off; and
the first adder, operable to provide the sense signal in respond to the sensed current and the reference signal.

8. The LED circuit of claim 7, wherein the second switch is controlled ON/OFF in-phase with the main switch, the third switch is controlled ON/OFF anti-phase with the main switch.

9. The LED circuit of claim 6, wherein the modulate unit is a constant on-time modulation circuit.

10. The LED circuit of claim 6, wherein the modulate unit is a PWM modulation circuit.

11. The LED circuit of claim 6, wherein the compensation unit comprises:
an operation amplifier, operable to receive the sense signal and the reference signal, the operation amplifier operable to amplify the difference between the sense signal and the reference signal; and
a RC filter, coupled between the output of the operation amplifier and ground.

12. A method for controlling the average current of a LED, comprising:
(a) sensing the current flowing through a main switch in a switch circuit by mid-current sense to get a sense signal;
(b) compensating the sense signal to get a compensated signal;
(c) modulating the compensated signal by constant on-time regulation to get a modulated signal; and
(d) sending the modulated signal to a drive circuit to get a drive signal which is used to control the ON/OFF of the main switch.

13. The method of claim 12, wherein (a) further comprises:
providing a mid-pulse signal at the right mid time point of the main switch's ON time of each cycle;
sensing the current flowing through the main switch using the mid-pulse signal to get a mid-current; and
holding the mid-current to get the sense signal.

14. A method for controlling the average current of a LED, comprising:
(a) sensing the current flowing through a main switch by full-wave sense to get a sense signal;
(b) compensating the sense signal to get a compensated signal;
(c) modulating the compensated signal to get a modulated signal; and
(d) sending the modulated signal to a drive circuit to get a drive signal which is used to control the ON/OFF of the main switch.

15. The method of claim 14, wherein step 1 further comprises:
receiving the current flowing through the main switch at a first adder when the main switch is turned on; and
receiving a reference signal at the first adder when the main switch is turned off.
